(19) United States
(12) Patent Application Publication
(10) Pub. No.: US 2015/0102543 A1
(43) Pub. Date: Apr. 16, 2015

(54) HYDRAULIC BUSHING OF VEHICLE

(71) Applicants: Hyundai Motor Company, Seoul (KR); HYUNDAI MOBIS CO., LTD., Seoul (KR); DAEHEUNG R&T CO., LTD., Gimhae-si (KR); Kia Motors Corp., Seoul (KR)

(72) Inventors: Ha Kyung Moon, Hwaseong-si (KR); Jae Hun Kim, Hwaseong-si (KR); Se Il Kim, Suwon-si (KR); Seong Hack Lee, Anyang-si (KR); Jong Sung Park, Yongin-si (KR); Sung Wook Park, Busan (KR)

(73) Assignees: Hyundai Motor Company, Seoul (KR); HYUNDAI MOBIS CO., LTD., Seoul (KR); DAEHEUNG R&T CO., LTD., Gimhae-si (KR); Kia Motors Corp., Seoul (KR)

(21) Appl. No.: 14/109,780

(22) Filed: Dec. 17, 2013

(30) Foreign Application Priority Data
Oct. 11, 2013 (KR) 10-2013-0121283

(51) Int. Cl. F16F 13/14

(52) U.S. Cl. CPC F16F 13/1409; F16F 13/1463; F16F 13/1418
USPC 267/140.12

(57) ABSTRACT

A hydraulic bushing of a lower arm for a vehicle includes an inner pipe, an outer pipe, an elastic member disposed between the inner and outer pipes and connecting the inner pipe to the outer pipe, and a fluid chamber defined in the elastic member. Fluid is sealed inside the fluid chamber. A stopper protrudes radially from an outer circumference of the inner pipe toward the outer pipe. The elastic member is coupled to the stopper such that the elastic member surrounds the stopper.

### CROSS-REFERENCE TO RELATED APPLICATION

The present application claims priority of Korean Patent Application Number 10-2013-0121283 filed on Oct. 11, 2013, the entire contents of which application are incorporated herein for all purposes by this reference.

### BACKGROUND OF INVENTION

1. Field of Invention

The present invention relates, in general, to a hydraulic bushing of a vehicle, and, more particularly, to a hydraulic bushing of a vehicle which can prevent an elastic body from being damaged, thereby improving endurance.

2. Description of Related Art

As shown in FIG. 2, the conventional hydraulic bushing 10 includes an inner pipe 11, an outer pipe 12, and an elastic member 13 connecting the inner pipe 11 to the outer pipe 12. The elastic member 13 is generally made of rubber, and is elastically deformed in a radial direction by an external force transmitted from a wheel, thereby minimizing vibration transmitted to the sides of a vehicle body.

The elastic member 13 is coupled to the outer surface of the inner pipe 11 and the inner surface of the outer pipe 12 through curing bonding, in which the portions of the elastic member 13 coupled with the outer pipe 12 come into contact with middle rings 14 coupled to the outer pipe 12.

The elastic member 13 has defined a fluid chamber 15 between the elastic member 13 and the outer pipe 12, in which fluid is contained in the fluid chamber 15. When a radial load is applied to the hydraulic bushing 10, the resistance of the fluid contained in the fluid chamber 15 to movement generates a vibration damping force.

In addition, the elastic member 13 has a protrusion 16 protruding radially to the outer pipe 12, and the outer pipe 12 has a stopper 17 which faces the protrusion 16. The stopper 17 can be made of steel or a synthetic resin, as a structure separate from the outer pipe 12.

The protrusion 16 and the stopper 17 come into contact with each other when the elastic member 13 is elastically deformed in the radial direction. This consequently minimizes a change in the cross-sectional area of the fluid chamber 15, thereby minimizing a change in the vibration damping characteristic of the hydraulic bushing 10.

In addition, the stopper 17 has defined therein flow paths 18 through which the fluid contained in the fluid chamber 15 can flow. The flow paths 18 are the spaces through which the fluid inside the fluid chamber 15 flows when the cross-sectional area of the fluid chamber 15 is changed through the elastic deformation of the elastic members 13. The flow paths 18 serve to improve the vibration damping characteristic.

In the foregoing hydraulic bushing 10 of related art, however, the protrusion 16 of the elastic member 13 which defines the fluid chamber 15 comes into direct contact with the stopper 17 when the elastic member 13 is elastically deformed in a radial direction by an external force. If the protrusion 16 repeatedly comes into contact with the stopper 17 over a long period of time, fatigue in the protrusion 16 made of rubber is increased, thereby resulting in a damage or fracture. In this case, the fluid chamber 15 is damaged, so that fluid inside the fluid chamber 15 leaks. This consequently lowers the endurance of the hydraulic bushing 10, thereby further decreasing the longevity thereof.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the related art, and the present invention is intended to provide a hydraulic bushing of a vehicle in which a stopper for maintaining the shape of a fluid chamber is provided on an inner pipe such that the stopper does not come into direct contact with a surrounding elastic member when the elastic member is elastically deformed in a radial direction by an external force, thereby preventing the elastic member and the fluid chamber from being damaged by the stopper. This can consequently increase the overall endurance of the hydraulic bushing, thereby improving product value.

In order to achieve the above object, according to one aspect various aspects of the present invention provide for a hydraulic bushing of a lower arm for a vehicle that includes: an inner pipe; an outer pipe; an elastic member disposed between the inner and outer pipes and connecting the inner pipe to the outer pipe; a fluid chamber defined in the elastic member, wherein fluid is sealed inside the fluid chamber; and a stopper protruding radially from an outer circumference of the inner pipe toward the outer pipe. The elastic member is coupled to the stopper such that the elastic member surrounds the stopper.

The stopper may protrude into the fluid chamber. The fluid chamber may be opened toward the outer pipe. The fluid chamber may include an upper fluid chamber and a lower fluid chamber divided by the stopper. The upper fluid chamber and the lower fluid chamber may be connected to each other through a connecting passage between one end of the stopper and the outer pipe.

to include two fluid chambers having substantially the same shape. The two fluid chambers may be formed substantially symmetrically on both sides of the inner pipe. The two fluid chambers may be connected to each other through a fluid passage which is formed circumferentially in the elastic member.

According to various aspects of the present invention, since the stopper is provided on the inner pipe, the portion of the elastic member which defines therein the fluid chamber is prevented from being damaged or broken by the stopper. This can significantly reduce fatigue in the elastic member, thereby increasing the overall endurance of the hydraulic bushing.

In addition, it is possible to further activate a fluid flow in response to a change in the cross-sectional area of the fluid chamber through the connecting passage which connects the upper and lower fluid chambers to each other and the flow path which connects the two fluid chambers to each other, thereby further increasing the vibration damping characteristic of the hydraulic bushing.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 a perspective view showing a lower arm having a hydraulic bushing;

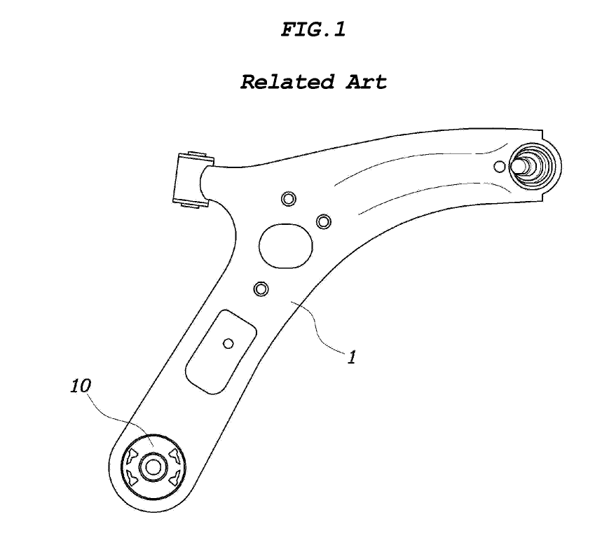

FIG. 2 is a cutaway perspective view showing a hydraulic bushing of the related art;

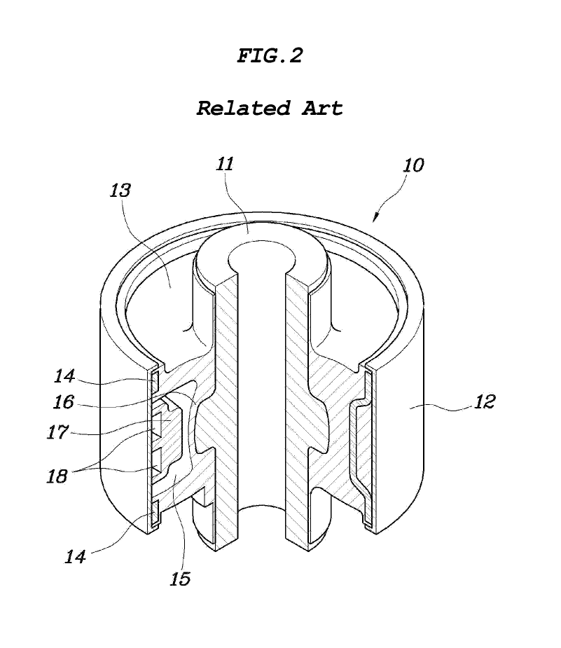

FIG. 3 is a cutaway perspective view showing an exemplary hydraulic bushing according to the invention;

FIG. 4 is a front view showing the fluid chamber shown in FIG. 3 from which the outer pipe is removed; and

FIG. 5 is a right side elevation view of the fluid chamber shown in FIG. 4.

### DETAILED DESCRIPTION

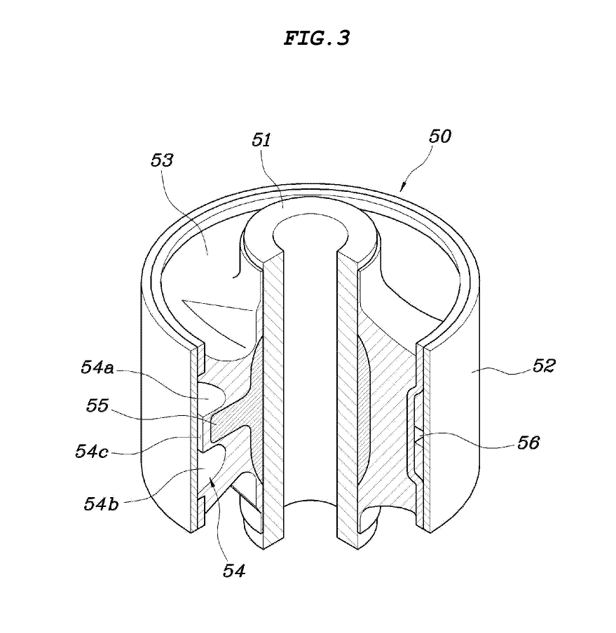

Referring to FIG. 3 to FIG. Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

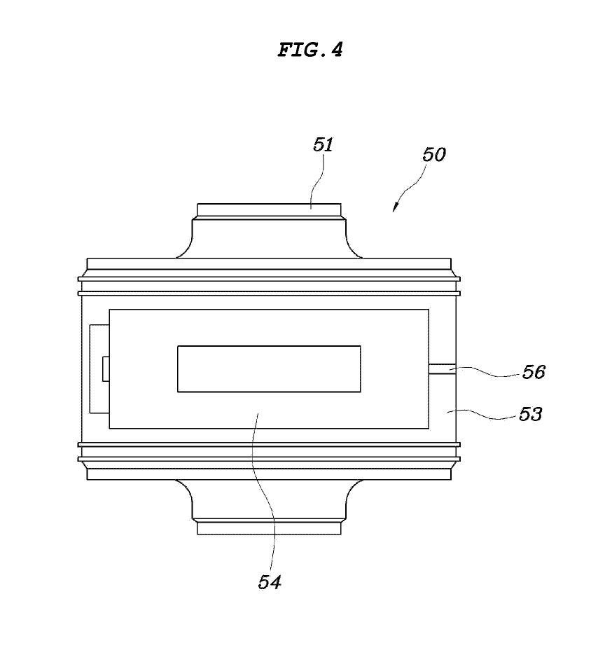

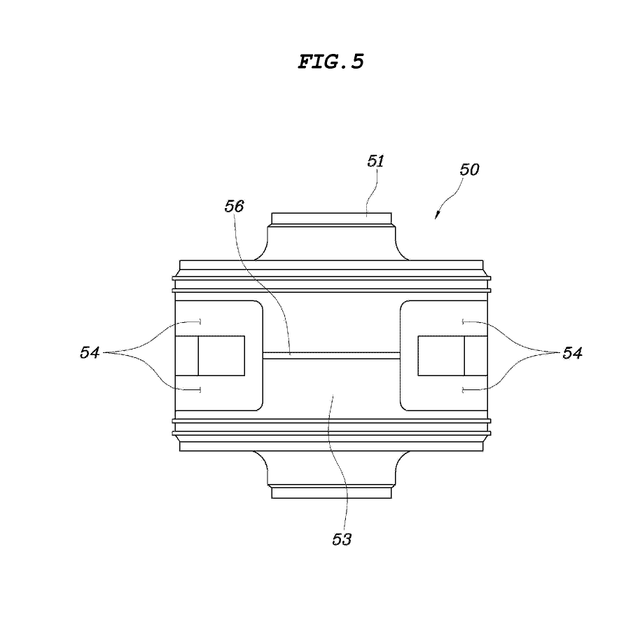

Referring to FIG. 3 to FIG. 5, a hydraulic bushing 50 of a vehicle according to various embodiments of the invention is mounted on one end of a lower arm which is a component of a suspension unit of the vehicle in order to connect the lower arm to a vehicle body (a sub-frame). The hydraulic bushing 50 includes an inner pipe 51, an outer pipe 52, and an elastic member 53 made of rubber or the like. The elastic member 53 connects the inner pipe 51 to the outer pipe 52. The elastic member 53 is coupled to the outer surface of the inner pipe 51 and the inner surface of the outer pipe 52, for example, through curing bonding.

In addition, the elastic member 53 has defined fluid chambers 54 between the elastic member 53 and the outer pipe 52, in which fluid is contained in the fluid chambers 54. The fluid chambers 54 are opened toward the outer pipe 52, and airtightness is maintained by the outer pipe 52.

The fluid sealed in the fluid chambers 54 flows along the fluid chambers 54 when a radial load is applied to the hydraulic bushing 50. In this process, the resistance of the fluid to the movement generates a vibration damping force, thereby minimizing vibration transmitted to the vehicle body.

The hydraulic bushing 50 according to various embodiments has a stopper 55 protruding radially from the outer circumference of the inner pipe 51 to the outer pipe 52. The stopper 55 can be made of steel or a synthetic resin, as a structure separate from the inner pipe 51. The stopper 55 can be formed integrally or monolithically with the inner pipe 51 as desired.

When the radial load is applied to the hydraulic bushing 50 and thus the elastic member 53 is elastically deformed in the direction toward the outer pipe 52, a direct contact of the stopper 55 to the outer pipe 52 may cause the outer pipe 52 and the stopper 55 to be damaged. In order to prevent this, the elastic member 53 is coupled to the stopper 55 such that it surrounds the stopper 55.

The elastic member 53 which surrounds one end of the stopper 55 comes into contact with the outer pipe 52 when the load is applied. This consequently minimizes a change in the cross-sectional area of the fluid chambers 54, thereby minimizing a change in the vibration damping characteristic of the hydraulic bushing 50.

As described above, the stopper 55 is provided on the inner pipe 51 and the portion of the elastic member 53 which defines the fluid chambers 54 is coupled with the stopper 55 such that it surrounds the stopper 55. Accordingly, even if the elastic member 53 is elastically deformed in a radial direction by an external force, the stopper 55 in the resultant structure does not transfer or transmit the load to the elastic member 53 which defines the fluid chambers 54.

Accordingly, the hydraulic bushing 50 according to various embodiments can prevent the elastic member 53 from being damaged or broken by the stopper 55, and thus reduce fatigue in the elastic member 53. In addition, the overall endurance of the hydraulic bushing 50 can be significantly increased.

In addition, each of the fluid chambers 54 is divided into an upper fluid chamber 54a and a lower fluid chamber 54b by the stopper 55. The upper fluid chamber 54a and the lower fluid chamber 54b are connected to each other through a connecting passage 54c between one end of the stopper 55 and the outer pipe 52.

The connecting passage 54c which connects the upper fluid chamber 54a to the lower fluid chamber 54b defines the space along which the fluid inside each fluid chamber 54 flows when the cross-sectional area of each fluid chamber 54 is changed through the elastic deformation of the elastic member 53, thereby increasing the vibration damping characteristic of the hydraulic bushing 50.

In addition, the fluid chambers 54 include two chambers having substantially the same or similar shape, and the respective fluid chambers 54 are formed symmetrically or substantially symmetrically on both sides of the inner pipe 51.

Since the two fluid chambers 54 are formed symmetrically or substantially symmetrically, there is provided a more reliable configuration which can further increase the vibration damping characteristic of the hydraulic bushing 50.

The fluid path 56 defines the space through which fluid flows from one fluid chamber 54 to the opposite fluid chamber 54 when the cross-sectional area of the one fluid chamber 54 is reduced through the elastic deformation of the elastic member 53. This consequently improves the vibration damping characteristic of the hydraulic bushing 50.

As described above, in the hydraulic bushing 50 according to various embodiments, the stopper 55 is provided on the inner pipe 51, and the portion of the elastic member 53 which defines therein the fluid chamber 54 surrounds the stopper 55. Accordingly, even if the elastic member 53 is elastically deformed in the radial direction by an external force, the stopper 55 does not transfer or transmit the load to the elastic member 53 which defines therein the fluid chambers 54.

Accordingly, the hydraulic bushing 50 according to various embodiments has the following advantages. It is possible to prevent the elastic member 53 from being damaged or broken by the stopper 55, thereby significantly reducing fatigue in the elastic member 53. Furthermore, the overall endurance of the hydraulic bushing 50 can be significantly increased, thereby improving product value.

In addition, in the hydraulic bushing 50 according to various embodiments, each of the fluid chambers 54 in which the fluid is sealed is divided into the upper and lower fluid chambers 54a and 54b by the stopper 55, and the upper and lower fluid chambers 54a and 54b are connected to each other through the connecting passage 54c. It is therefore possible to promote a fluid flow inside the fluid chambers 54 through the connecting passage 54c, thereby further improving the vibration damping characteristic of the hydraulic bushing 50.

Furthermore, in the hydraulic bushing 50 according to various embodiments, the two fluid chambers 54 in which fluid is sealed are formed symmetrically, thereby providing a more reliable configuration which can further increase the vibration damping characteristic of the hydraulic bushing 50.

In addition, it is possible to cause fluid to flow along the fluid chambers 54 through the flow passage 56 which connect the two fluid chambers 54 to each other, when a change in the cross-sectional area of the fluid chambers 54 is occurred, thereby further increasing the vibration damping characteristic of the hydraulic bushing 50.

Although For convenience in explanation and accurate definition in the appended claims, the terms “upper” or “lower”, “inner” or “outer”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A hydraulic bushing of a lower arm for a vehicle comprising:
an inner pipe;
an outer pipe;
an elastic member disposed between the inner and outer pipes and connecting the inner pipe to the outer pipe;
a fluid chamber defined in the elastic member, wherein a fluid is sealed inside the fluid chamber; and
a stopper protruding radially from an outer circumference of the inner pipe toward the outer pipe,
wherein the elastic member is coupled to the stopper such that the elastic member surrounds the stopper.

2. The hydraulic bushing according to claim 1, wherein the stopper protrudes into the fluid chamber.

3. The hydraulic bushing according to claim 1, wherein the fluid chamber is opened toward the outer pipe.

4. The hydraulic bushing according to claim 1, wherein the fluid chamber comprises an upper fluid chamber and a lower fluid chamber divided by the stopper, wherein the upper fluid chamber and the lower fluid chamber are connected to each other through a connecting passage between one end of the stopper and the outer pipe.

5. The hydraulic bushing according to claim 1, wherein the fluid chamber comprises two fluid chambers having substantially a same shape, wherein the two fluid chambers are formed substantially symmetrically on both sides of the inner pipe.

6. The hydraulic bushing according to claim 5, wherein the two fluid chambers are connected to each other through a fluid passage which is formed circumferentially in the elastic member.
